(19) United States
(12) Patent Application Publication
(10) Pub. No.: US 2016/0149969 A1
(43) Pub. Date: May 26, 2016

(54) MULTI-DEVICE COLLABORATION

(71) Applicant: MICROSOFT TECHNOLOGY LICENSING, LLC, REDMOND, WA (US)

(72) Inventors: RYAN MICHAEL FARMER, REDMOND, WA (US); BORA BERAN, BOTHELL, WA (US); XingZhao LIU, REDMOND, WA (US); STEPHEN HOYT HOUCHEN, REDMOND, WA (US)

(21) Appl. No.: 14/555,214

(22) Filed: Nov. 26, 2014

(51) Int. Cl. H04L 29/06; H04L 29/08

(52) U.S. Cl. CPC H04L 65/403; H04L 67/10; H04L 67/16

(57) ABSTRACT

Aspects of the present invention relate generally to a method of automatically selecting a collaboration mechanism for content to be shared between a source computing device and a destination computing device. The collaboration mechanism may be one of multiple collaboration mechanisms available to a collaboration application. Aspects of the present invention can automatically select the collaboration mechanism that is optimized for the present network conditions, hardware conditions, and quality requirements to share the selected content. Many of the network and processing conditions utilized by aspects of the present invention are not readily available or discernible by a user selecting a method.

### BACKGROUND

In the online collaboration/meeting space, there can be multiple methods of sharing content with other participants. Different sharing technology is optimized for different purposes. For example, sharing a desktop may be an effective way to make a presentation. However, to edit that presentation jointly, a person might instead want to share that file/program with another user so they could jointly make changes at the same time.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Aspects of the present invention relate generally to a method of automatically selecting a collaboration mechanism to share content between a source computing device and a destination computing device. The collaboration mechanism may be one of multiple collaboration mechanisms available to a collaboration application.

All of the available collaboration mechanisms can make picking an acceptable sharing mechanism a time consuming process for a user. Presently, a user may be asked to select a collaboration mechanism. The user is likely to select a collaboration mechanism based on past experience without considering network conditions, hardware characteristics, and other factors. As a result, a user can pick a collaboration mechanism that produces an aesthetically displeasing collaboration session as well as one that is technologically inefficient.

Aspects of the present invention can automatically select the collaboration mechanism that is optimized for the present network conditions, hardware conditions, and quality requirements to share the selected content. Many of the network and processing conditions utilized by aspects of the present invention are not readily available or discernible by a user selecting a method. Further, a user may not understand how various components within the collaboration environment affect the choice of an optimum collaboration mechanism. A user might select a collaboration option that makes inefficient use of available computer and network resources. Aspects of the invention save the user time and can result in a more efficient use of computer and network resources by evaluating the collaboration environment to select an efficient collaboration mechanism that also satisfies the user's collaboration intent.

### BRIEF DESCRIPTION OF THE DRAWINGS

Aspects of the invention are described in detail below with reference to the attached drawing figures, wherein:

FIG. 1 is a block diagram of an exemplary computing environment suitable for implementing aspects of the invention;

FIG. 2 is a diagram depicting a distributed computing environment, in accordance with an aspect of the present invention;

FIG. 3 is a flow chart depicting a decision process to select a collaboration mechanism, in accordance with an aspect of the present invention;

FIG. 4 is a flow chart depicting a decision process to select a collaboration mechanism, in accordance with an aspect of the present invention;

FIG. 5 is a diagram depicting a collaborative computing architecture;

FIG. 6 is a diagram depicting a method of selecting a collaboration mechanism to share content from a source computer device to a destination computer device, in accordance with an aspect of the present invention; and

FIG. 7 is a diagram depicting a method of selecting a collaboration mechanism to share content from a source computer to a destination computer, in accordance with an aspect of the present invention.

### DETAILED DESCRIPTION

The subject matter of aspects of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Aspects of the present invention relate generally to a method of automatically selecting a collaboration mechanism for content to be shared between a source computing device and a destination computing device. The collaboration mechanism may be one of multiple collaboration mechanisms available to a collaboration application. The collaboration mechanisms can support the sharing of desktops, monitors, or individual applications (via process, window, or screen region) between the computing devices. Additionally, the collaboration application may also support file transfer (i.e., the ability for users to exchange documents between two or more users).

A collaboration application allows people to synchronously communicate with each other. Collaboration applications can facilitate synchronous communication, such as voice and video conferencing. Collaboration applications can also facilitate content sharing during a collaboration session. Exemplary content sharing includes sharing a desktop, sharing an application window, and a file transfer. Desktops and application windows can be shared through web access companion technology or through a special protocol that transfers a converted version of the content to software on the destination device that can render the converted content. In addition to these broad sharing categories, within the categories different resolutions and other characteristics can be selected. The collaboration application may comprise a unified communications platform which may include, but is not limited to, functionality for instant messaging, presence, file transfer, peer-to-peer and multiparty voice and video calling, ad hoc and structured conferences (audio, video, and web), and public switched telephone network (“PSTN”) connectivity.

All of the available options and setups for the collaboration mechanisms can make picking an acceptable collaboration mechanism a time consuming process for a user. Presently, a user may be asked to select a collaboration mechanism. The user is likely to select a collaboration mechanism based on past experience without considering network conditions, hardware characteristics, and other factors. As a result, a user can pick a collaboration mechanism that produces an aesthetically displeasing collaboration session as well as one that is technologically inefficient.

Aspects of the present invention can automatically select a collaboration mechanism that is optimized for the present network conditions, hardware conditions, and quality requirements to share the selected content. Many of the network and processing conditions utilized by aspects of the present invention are not readily available or discernible by a user selecting a collaboration mechanism. Further, a user may not understand how various components within the collaboration environment affect the choice of an optimum collaboration mechanism. A user might select a collaboration option that makes inefficient use of available computer and network resources. Aspects of the invention save the user time and can result in a more efficient use of computer and network resources by evaluating the collaboration environment to select an efficient collaboration mechanism that also satisfies the user's collaboration intent.

Various aspects of the invention may access computer profile information for both source and destination computing devices. The computer profile information can include installed programs, hardware characteristics, available bandwidth, and similar computing aspects. Aspects of the invention can provide an opt-in or opt-out interface that allows the user to provide or withhold permission to share the computer profile information.

Various aspects of the invention may record and access user profile information. User profile information includes explicit user collaboration preferences and a record of collaboration technology used or selected in previous collaboration sessions. The user profile information can also include names, email addresses, and other personal information. Aspects of the invention can provide an opt-in or opt-out interface that allows the user to provide or withhold permission to share the user profile information.

Having briefly described an overview of aspects of the invention, an exemplary operating environment suitable for use in implementing aspects of the invention is described below.

### Exemplary Operating Environment

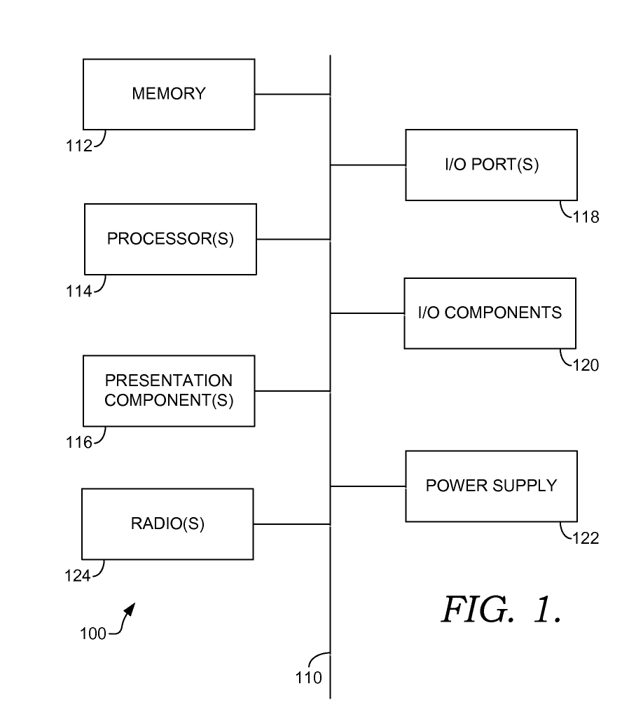

Referring to the drawings in general, and initially to FIG. 1 in particular, an exemplary operating environment for implementing aspects of the invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the invention may be practiced in a variety of system configurations, including handheld devices, consumer electronics, general-purpose computers, specialty computing devices, etc. Aspects of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component 120. Also, processors have memory. The inventors hereof recognize that such is the nature of the art, and reiterate that the diagram of FIG. 1 is merely illustrative of an exemplary computing device that can be used in connection with one or more aspects of the invention. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer storage media in the form of volatile and/or nonvolatile memory. The memory 112 may be removable, non-removable, or a combination thereof. Exemplary memory includes solid-state memory, hard drives, optical-disc drives, etc. Computing device 100 includes one or more processors 114 that read data from various entities such as bus 110, memory 112, or I/O components 120. Presentation component(s) 116 present data indications to a user or other device. Exemplary presentation components 116 include a display device, speaker, printing component, vibrating component, etc. I/O ports 118 allow computing device 100 to be logically coupled to other devices including I/O components 120, some of which may be built in.

Illustrative I/O components include a microphone, joystick, game pad, satellite dish, scanner, printer, display device, wireless device, a controller (such as a stylus, a keyboard and a mouse), a natural user interface (NUI), and the like. In embodiments, a pen digitizer (not shown) and accompanying input instrument (also not shown but which may include, by way of example only, a pen or a stylus) are provided in order to digitally capture freehand user input. The connection between the pen digitizer and processor(s) 114 may be direct or via a coupling utilizing a serial port, parallel port, and/or other interface and/or system bus known in the art. Furthermore, the digitizer input component may be a component separated from an output component such as a display device, or in some embodiments, the usable input area of a digitizer may be co-extensive with the display area of a display device, integrated with the display device, or may exist as a separate device overlaying or otherwise appended to a display device. Any and all such variations, and any combination thereof, are contemplated to be within the scope of embodiments of the present invention.

An NUI processes air gestures, voice, or other physiological inputs generated by a user. Appropriate NUI inputs may be interpreted as ink strokes for presentation in association with the computing device 100. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 100. The computing device 100 may be equipped with depth cameras, such as stereoscopic camera systems, infrared camera systems, RGB camera systems, and combinations of these for gesture detection and recognition. Additionally, the computing device 100 may be equipped with accelerometers or gyroscopes that enable detection of motion. The output of the accelerometers or gyroscopes may be provided to the display of the computing device 100 to render immersive augmented reality or virtual reality.

A computing device may include a radio. The radio transmits and receives radio communications. The computing device may be a wireless terminal adapted to receive communications and media over various wireless networks. Computing device 100 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

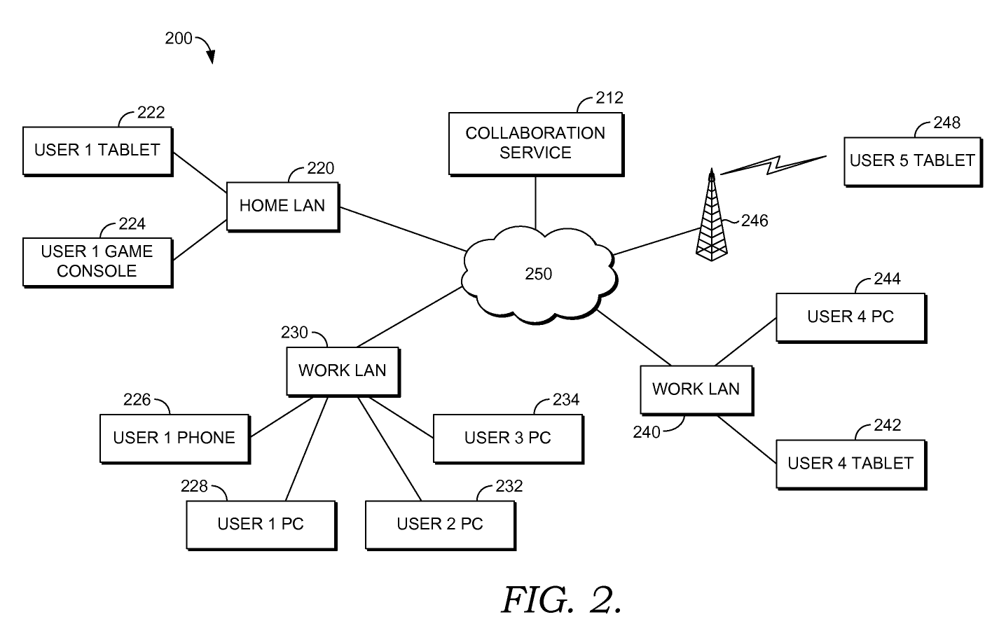

Turning now to FIG. 2, a multi-device computing environment 200 is illustrated. Two or more devices within FIG. 2 can communicate with each other to form a collaboration session during which content can be communicated.

As used herein, a collaboration environment includes a source computing device that is sharing content and one or more destination computing devices which are receiving content. Though described as receiving and sending computers, in a collaborative environment, a receiving computer can quickly transition to a sending computer and vice versa. As aspects of the present invention relate to sharing selected content, the source computer is the device through which the user designated the content to be shared. The content itself could be stored within computer memory on the source computing device or in a remote storage, for example, in a data center or other storage mechanism accessible through a local area network or wide area network. In one aspect, the selected content is not stored on the receiving devices initially.

The collaboration environment comprises the source computing device, the one or more destination computing devices, and the network over which content is to be communicated between devices. Additionally, the one or more computing devices (e.g., data center servers) that facilitate a collaboration service 212 may also be considered part of the collaboration environment for certain aspects of the present invention. The collaboration service 212 can create bridges between devices for video sharing, voice conferencing, and other collaboration techniques. In other aspects, the collaborative environment does not include a collaboration service 212.

The collaboration service 212 can reside in a data center or multiple data centers that are accessible through a wide area network, such as the Internet. The collaboration service 212 may be allocated a certain amount of computing resources at a particular time when a collaboration session is occurring. The amount of resources assigned to a collaboration service 212 can vary from time to time. Relevant computing resources include available processing, video rendering, and networking resources.

The collaboration environment allows users one, two, three, four, and five to collaborate with each other over various devices. As can be seen, users may be associated with one or more devices. The collaboration environment connects the devices through wide area network 250, which could be the Internet. The wide area network 250 is connected to a collaboration service 212, which can enable one or more different kinds of collaboration mechanisms. The wide area network 250 is also connected to several local area networks including a home LAN 220, first work LAN 230, a second work LAN 240, and a mobile access network 246 represented by a cell tower.

User 1 is associated with multiple computing devices including a user 1 tablet 222, a user 1 game console 224, a user 1 phone 226, and a user 1 PC 228. The user 1 tablet 222 and the user 1 game console 224 connect to the wide area network 250 through home LAN 220. Home LAN 220 may include both wireless and wired connections. The user 1 phone 226 and the user 1 PC 228 are connected to the wide area network 250 through the first work LAN 230. The second user is associated with a user 2 PC 232, which is connected to the first work LAN 230. The third user is associated with a user 3 PC 234, which is also connected to the first work LAN 230. A user 4 tablet 242 and a user 4 PC 244 are connected to the second work LAN 240. The user 5 tablet 248 is connected to the mobile access network 246.

Participating in an active collaboration session requires a user to be actively engaged with a computing device. A user may be simultaneously engaged with multiple computing devices, for example, a user could be logged in to their PC while making a phone call on their smartphone. However, for purposes of the collaboration session, the user must be engaged in the collaboration application to be part of the session. The multiple devices associated with some users illustrate that it can be difficult to select the optimum collaboration mechanism when it may not be entirely clear to a source user what device a destination user is actively using. The collaboration service 212 may facilitate a login or registration process that is able to determine characteristics of a device that a person is using within a collaboration environment.

Aspects of the present invention automatically select a collaboration mechanism for content to be shared from a source device to one or more destination devices. The sharing can occur within a collaboration application. For example, an ongoing collaboration session could be underway between users 1, 4, and 5. User 1 is using the user 1 game console 224 to access the collaboration session. User 4 is using the user 4 tablet 242 to access the collaboration session, and user 5 is using the user 5 tablet 248 to access the collaboration session. In this example, the only devices within the collaboration environment are the user 1 game console 224, the user 4 tablet 242, and the user 5 tablet 248. The collaboration environment also includes the home LAN 220, the wide area network 250, the second work LAN 240, and the mobile access network 246. In this example, the first work LAN 230 is not part of the collaboration environment because devices connected to the first work LAN 230 are not actively participating in the collaboration session. The collaboration service 212 and computing devices that facilitate the collaboration service are also part of the collaboration environment, in this example.

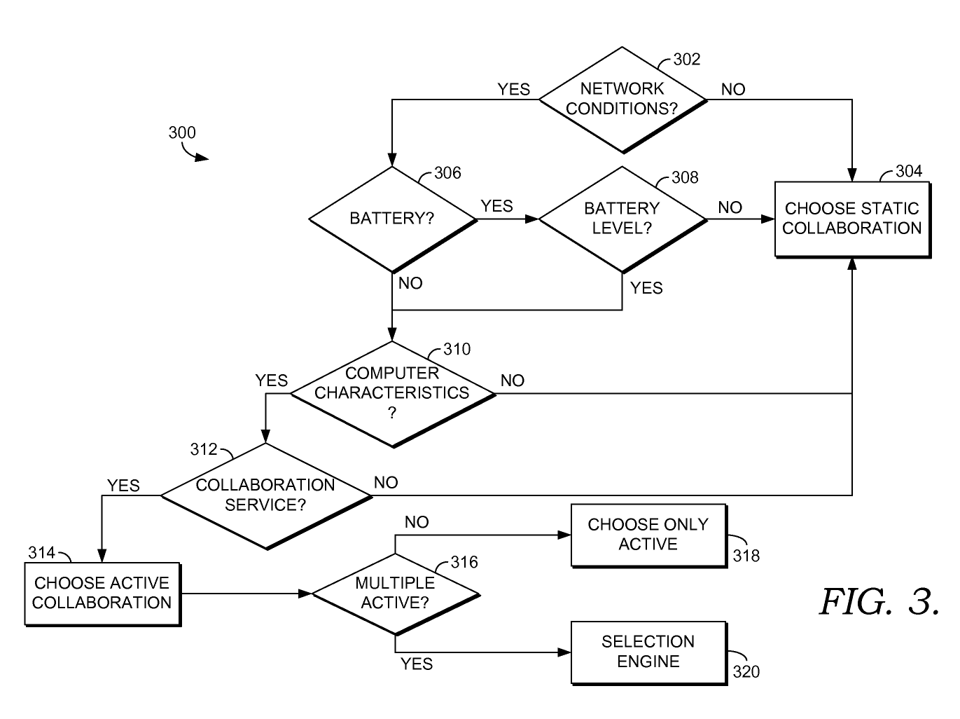

During the collaboration session, user 1 may wish to share a presentation with the other users in the collaboration session. User 1 may select the content through a user interface provided by the collaboration application and designate it for sharing with individual members within the collaboration session or all members within the collaboration session. Aspects of the present invention will then evaluate attributes of the collaboration environment to determine an optimal collaboration mechanism to share the selected content. Since user 1 selected the content, the user 1 game console 224 becomes the source computing device and the user 4 tablet 242 and the user 5 tablet 248 become destination computing devices. Notice that the source and destination designations for a particular device are related to a particular sharing event. The designations could change if user 4, for example, decided to share a second content with the other devices. An example of the process used and factors considered to select a collaboration mechanism for sharing are described in more detail with reference to FIGS. 3-7.

Turning now to FIG. 3, a decision process 300 designed to determine whether or not a static or active collaboration mechanism is selected is shown, in accordance with an aspect of the present invention. Whether to select from an active or static sharing mechanism can be based on whether thresholds for an active method are met by the collaboration environment. A different collaboration mechanism could be selected for each destination device in the environment. The decision process 300 is just one example of a process that could be used to select a collaboration mechanism. The decision process 300 may be combined with other decision processes, such as process 400, to select a collaboration mechanism.

An active collaboration mechanism provides real-time access to the content and real-time access to manipulations the source user performs on the content. For example, an active collaboration mechanism could show changes that the user makes to the content as the changes are made. The active collaboration mechanisms can also be defined in terms of a continuous bandwidth and processing usage. In one aspect, the active collaboration mechanism uses an average of at least 50 kbps, for example, at least 100 kbps, or at least 200 kbps, or at least 500 kbps during the collaboration session. As used in this context, “continuous” means the collaboration session continues for more than three minutes, for example ten minutes, or thirty minutes. The data transfer and processing may vary within the collaboration session and average the above listed rates. Exemplary active collaboration mechanisms include sharing a desktop and sharing an application window. When a desktop or application window is shared, the destination users can see what the source user sees in that application window. For example, the destination users could see a mouse pointer moving across the screen as the user manipulates the content. The active sharing mechanism can provide a richer user experience when network and device capabilities are able to handle the active collaboration. Otherwise, the active collaboration could be a poor user experience.

A static collaboration mechanism transfers the content in its entirety once and does not provide continuous updates of the source user's manipulation of the content. For example, transferring a file, such as a presentation or a document, is an example of a static collaboration mechanism.

The first decision point evaluates whether network conditions 302 satisfy one or more thresholds for active collaboration. The network thresholds can include available bandwidth through the source network, such as the home LAN 220 and the connection between the home LAN 220 and the wide area network 250. The network conditions can also include a network condition between the wide area network 250 and the collaboration service 212. This can be described as a data service network threshold. The available download bandwidth for the connection to the destination device can be compared with a threshold. The threshold can be equal to the bandwidth that will be consumed by an active sharing mechanism. Each destination device can be evaluated separately and different sharing mechanisms can be selected for different destination devices. In other words, if the bandwidth threshold is satisfied for the user 4 tablet 242, then an active sharing mechanism could be selected for the user 4 tablet 242. But if the threshold is not satisfied for the user 5 tablet 248, then a static sharing mechanism could be used for the user 5 tablet 248. This illustrates that the collaboration mechanism could be different for different destination devices depending on an evaluation of numerous factors.

In addition to available bandwidth, other data transfer related factors could be considered, such as a data limit to the user 5 tablet 248. If a data limit exists, then the user 5 tablet 248 could be considered not to meet the network threshold test or otherwise be designated for a static collaboration mechanism.

Returning to the decision process 300, if network conditions do not satisfy one or more thresholds for active collaboration, then a static collaboration mechanism is chosen 304. If the network conditions, and again network conditions can include network conditions at the source device, the collaboration service, and multiple destination devices, then a determination 306 is made whether one or more of the devices is running on battery power. In general, active collaboration mechanisms are more energy intensive and can drain a battery. While the user 1 game console 224 is unlikely to run on battery power, the user 4 tablet 242 and the user 5 tablet 248 could be running on battery or be plugged in. A laptop is another example of a device that could be running on battery or plugged in.

If one or more devices are on battery, then optionally, the battery charge level is compared 308 with a threshold. If the charge level is above a threshold, then the rest of the active collaboration decision process could be evaluated. If the battery level is below a charged threshold, then a static collaboration mechanism is chosen 304.

If none of the devices are running on battery at decision point 306, then the computers in the collaboration session are evaluated at decision point 310 for meeting threshold processing capability or availability requirements. At decision point 310, computer characteristics are evaluated to determine whether the present conditions are suitable for an active collaboration mechanism. The computer characteristics can include available processing, available codecs, and other characteristics that can impact the ability to use one or more active collaboration mechanisms. In one aspect, the threshold characteristics match those required for the least demanding active collaboration mechanism. For example, three different active collaboration mechanisms may be available, each having different demands. In this case, the overall threshold could be set to match the least demanding active collaboration mechanism available on the source computing device.

Other characteristics could include applications installed on the destination devices. For example, the active application may require a collaboration client to be installed on the destination computing device. If this client application is not installed, then the criteria for selecting active collaboration mechanisms may not be met. On the other hand, if multiple active collaboration mechanisms are available and only one of them requires a client that is not installed, then the criteria may be satisfied and the collaboration mechanism requiring the client to be installed can be eliminated from the viable choices. The elimination could occur through the selection engine 320, which is described subsequently. When only one active collaboration mechanism is possible, then the failure of a necessary client application to be installed in one of the source devices could cause the active selection criteria at decision point 310 to fail and cause a static collaboration mechanism to be chosen 304.

If all of the computer characteristics and attributes are compared against various thresholds and satisfied, then at decision point 312, the collaboration service can be evaluated for appropriate availability. As mentioned, the collaboration service can reside in one or more data centers and facilitate certain collaboration mechanisms. For example, an active collaboration mechanism that uses the collaboration service generates a web page that is shared through the collaboration service. In other words, the content is actively transferred from the source computing device to the collaboration service where it is transformed into a web content that is accessed through a browser on the source computing device. In order to perform this service, the collaboration service needs to have available processing. Accordingly, the present capabilities or availability of the collaboration service are evaluated for suitable availability to facilitate one or more active collaboration mechanisms. If the collaboration service does not have the available capacity, then a static collaboration mechanism can be chosen 304.

A variation on the availability of the collaboration service can be the use of a quality of service (“QOS”) assigned to a source user. Different source users may have different levels of access to the collaboration service. The quality of service could be compared with available capacity and used to determine whether or not the user is granted the capacity necessary, even if available, to facilitate active collaboration. For example, during times of peak demand, a user with a lower assigned QOS could be denied access to the collaboration service, while a user with higher assigned QOS would be granted access to the collaboration service.

If the network conditions, the battery conditions, the computer characteristics, and the collaboration service all satisfy criteria for active collaboration, then an active collaboration mechanism is chosen at step 314. The selection of active collaboration mechanisms can further include determining whether multiple active collaboration mechanisms are available on the source computing device and/or in conjunction with the destination device. For example, if multiple active collaboration mechanisms are available on the source device but necessary clients are not installed on the destination device, then only one active collaboration mechanism may be available in which case the only active collaboration mechanism is chosen at step 318. Otherwise, a selection engine 320 can be used to determine which of the available active collaboration mechanisms should be used. The selection engine 320 can go through a decision process. For example, the selection engine 320 could be a machine learning mechanism that is trained with editorial data to select an optimal collaboration mechanism. The automatic selection of the collaboration mechanism can optimize the use of computer resources on a source computing device, destination computing device, and/or server resources by selecting a technology that satisfies the user's quality needs instead of a default program or user selected program that can use more resources than needed to achieve the desired quality. The automated selection can also save a user's time by eliminating the need to select a collaboration mechanism. Instead, the user can select the content to be shared and the most efficient collaboration mechanism for sharing the content can be automatically selected. The selection engine 320 can take several factors into account to try to optimize the selection. These factors will be described subsequently and can include whether joint editing is selected, battery status of a collaboration device, and such.

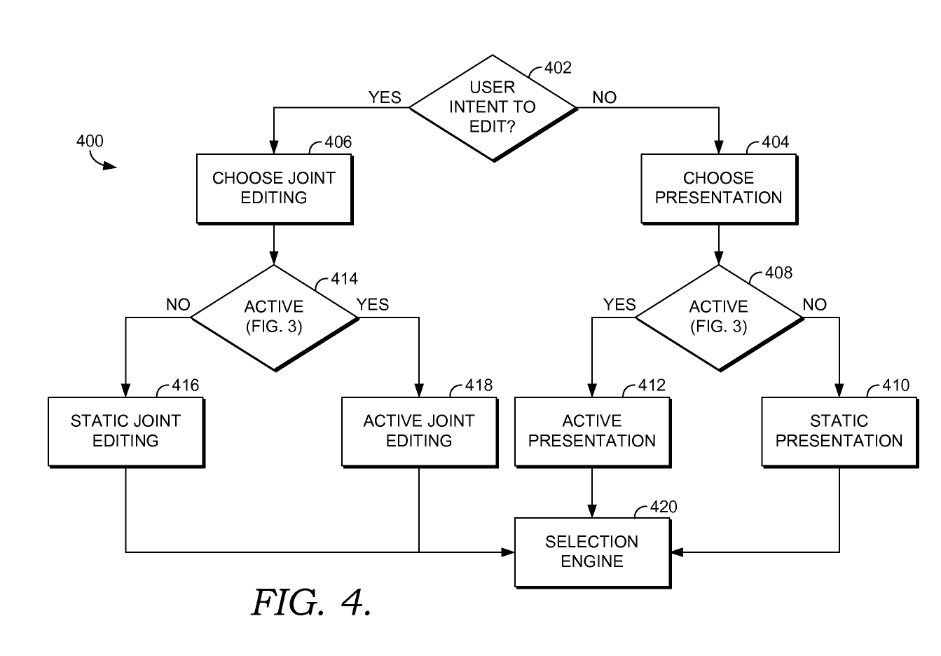

Turning now to FIG. 4, a flow chart illustrating a decision process 400 for selecting a collaboration mechanism capable of joint editing is shown, in accordance with an aspect of the present invention. The process 400 could be performed by a selection engine, such as selection engine 320. Some collaboration mechanisms allow multiple people to jointly edit content, such as a file, presentation, or spreadsheet, together from different computing devices. Other collaboration mechanisms do not allow joint editing but only presentation. A presentation collaboration mechanism allows destination users to view content and the source user's manipulations of the content but does not allow the destination users to change the content. Joint editing refers to directly editing the content, in contrast to making a suggestion over an audio or visual connection for the source user to make a correction or a change.

At decision point 402, an analysis is performed to determine whether the source user, who has selected the content to share, has an intent to jointly edit the content. The intent may be determined by an intent engine. The intent engine can run on the collaboration service, on the source device, or elsewhere. The intent engine may be a machine learning algorithm that is trained by a corpus of collaboration session characteristics tagged with editorial tags suggesting whether or not the user has an intent to edit jointly or to share.

For example, the location of each device within the collaboration session could be a factor used to determine whether or not the user has an intent to share. In general, users that are in close proximity to each other, for example, within a quarter of a mile, would tend to meet together for a presentation. On the other hand, a collaboration session may be intended when the users are within close proximity, so each user could have her own device to provide input. When users are dispersed further than the threshold proximity, then an intent to present may be inferred.

Other information like the type of content selected and a user's previous collaboration activity, especially with the same users in the present collaboration session, can be used to determine whether or not the user has an intent to share or edit.

If the user at decision point 402 is determined not to have an intent to edit, then a presentation optimized collaboration mechanism is chosen at step 404. In contrast, if an intent to edit is determined at decision point 402, then a joint-editing collaboration mechanism is chosen at step 406.

Decision points 408 and 414 both attempt to determine whether or not the collaboration environment supports active sharing. Active sharing mechanisms may be available for both presentation and joint editing. The active or static determination has been described previously with reference to FIG. 3 and can be applied to determine whether an active collaboration mechanism is optimal at decision point 414 and decision point 408.

If an active joint-editing mechanism is desired, then at step 418 an active joint-editing mechanism is selected from available active joint collaboration mechanisms.

If an active joint-editing system is not desired, then a static joint-editing system is chosen at step 416.

If an active presentation mechanism is desired, then at step 412 an active presentation mechanism is chosen.

If a static presentation mechanism is desired, then at step 410 a static presentation mechanism is chosen.

In each of steps 410, 412, 416, and 418, the choice may be fed to a selection engine 320 for further selection from available collaboration mechanisms. For example, at step 418 the selection engine 320 could be asked to select from several active joint-editing collaboration mechanisms.

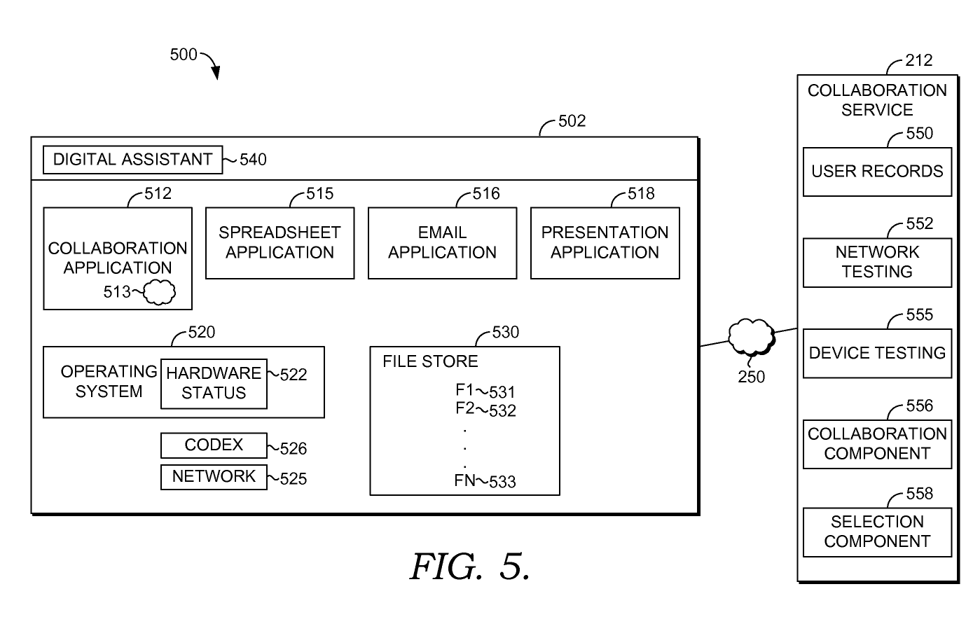

Turning now to FIG. 5, a collaborative computing environment 500 is shown, in accordance with an aspect of the present invention. The collaborative computing environment 500 includes a source computing device 502 and a collaboration service 212 which has been described previously. For simplicity, one or more destination devices are not included.

The source computing device 502 could be similar to computing device 100 described previously. The source computing device 502 includes an operating system 520. Operating systems are well known and will not be described in detail here. The operating system 520 has the ability to ascertain a hardware status of hardware on the source computing device 502. The collection of functions used to detect and report hardware status is described herein as the hardware status component 522. In an aspect, the hardware status component 522 is not part of the operating system and is instead a higher level application.

The hardware status component 522 can comprise a plurality of diagnostic tools and reporting tools that can report factors such as central processing unit usage (“CPU”) and graphic processing unit (“GPU”) capacity and present load. The hardware status component 522 can also report on available active memory and other limitations or characteristics that can impact the performance of a collaboration mechanism.

The source computing device 502 also includes one or more network interfaces 525 and one or more codices 526. Network interfaces can include a wireless radio and related software that allows the source computing device 502 to connect with a Wi-Fi network as well as an Ethernet connection, a USB port, or other mechanism for connecting to another device or network. The codices 526 provide the ability to encode and decode video. Codices can be associated with media players and other applications. Different devices can have different groups of codices available. In aspects of the invention, the selection component can choose a collaboration mechanism compatible with codices installed on destination and source devices.

The source computing device 502 includes a file store 530 with files 531, 532, and file N 533, where N is an integer such as 100; 1,000; 10,000; 100,000; or similar File store 530 designates content files, which can be differentiated from application files. A content file may be associated with an application through a file extension or other mechanism that communicates that a particular file is formatted for processing by an application. On the other hand, an application file enables the operation of an application and may alternatively be described as a program file and could have an extension such as .exe.

The applications on source computing device 502 include a collaboration application 512, a spreadsheet application 515, an email application 516, and a presentation application 518. The files in file store 530 could be associated with one of these applications or none of these applications. For example, the collaboration application 512 may not be associated with a particular type of file but could instead be capable of accessing multiple file types.

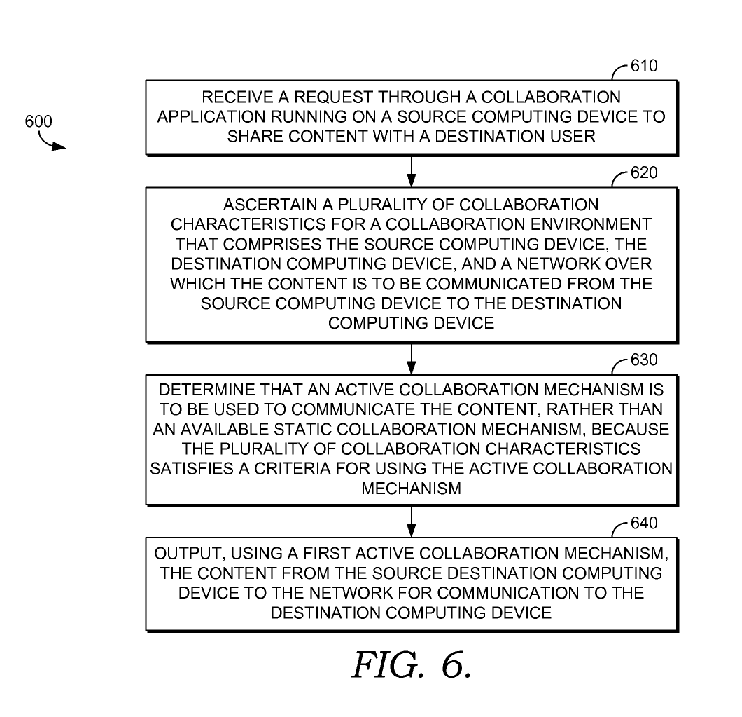

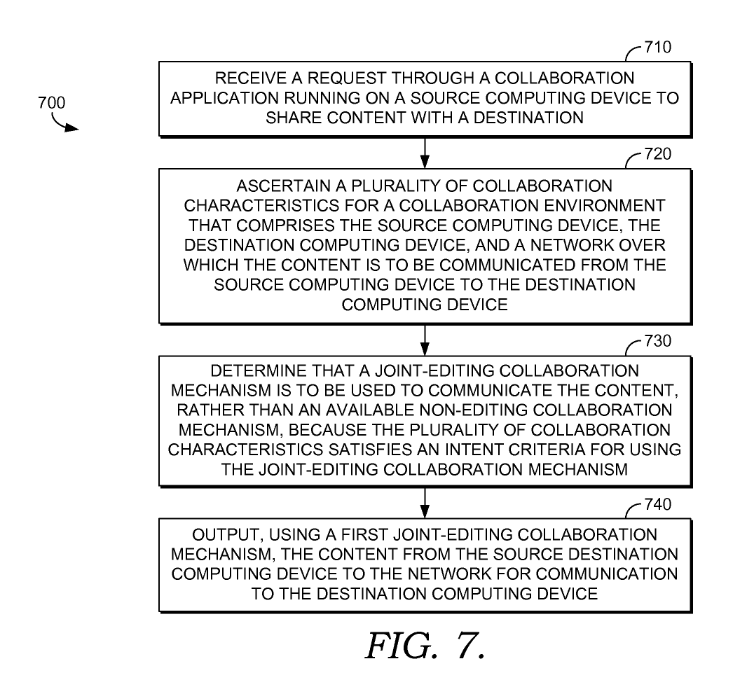

The collaboration application 512 includes selection component 513. The selection component 513 performs some of the selection mechanisms or methods described herein such as those described with reference to FIG. 3, FIG. 4, FIG. 6, and FIG. 7. The selection component 513 could be separate from the collaboration application 512 and operate as a stand-alone application. For example, a computing device could include multiple collaboration applications, and the selection component 513 could interface with multiple collaboration applications to optimize the selection of a collaboration mechanism under different circumstances.

The selection component 513 can evaluate various characteristics of the collaboration environment. Characteristics include those related to the source computing device, the destination computing device(s), and the system. The characters considered for the source computing device include source network characteristics including the connection type (e.g., wired/wireless/3G/LTE), latency, loss, and connection quality/signal strength. The destination characteristics can include screen size, mobile vs desktop vs tablet, touch, etc.

The digital assistant 540 can help manage a user's preferences and activities. The digital assistant 540 can provide information to the selection component 513 as well as the collaboration application or other applications, such as email application 516 operating on the source computing device. In particular, the digital assistant 540 can store a user's preferences, understand relationships between the user of a source device and other users within a collaboration session, etc. For example, the digital assistant 540 may be able to statistically infer through an analysis of previous contacts whether the users within a session are co-workers at the same company or work for different companies. The digital assistant 540 could also determine whether or not the users in the collaboration session have a history of communication with each other and infer a closeness of their relationship. This information may be fed into a decision engine or intent engine as described previously to help select an optimal collaboration mechanism. For example, some collaboration mechanisms provide greater levels of security than other collaboration mechanisms. When one or more of the participants in a collaboration session work for different entities, then a preference for increased security may be inferred and a collaboration mechanism with higher security may be selected. The digital assistant 540 may also interface with a collaboration application 512 to help identify user addresses and hardware to set up a collaboration session.

The collaboration service 212 helps facilitate collaboration sessions. The collaboration service 212 may reside in a data center. The collaboration service 212 may be allocated a finite number of computer resources at any given time. The computing resources can include active memory, network resources, and processing capability. The processing capability can include both CPU and GPU-related functions. In one aspect, the collaboration service 212 is used to negotiate a collaboration session between various users. In other words, the communications can be passed through the collaboration service or the collaboration service can facilitate the direct communication between clients.

The collaboration service includes a user records component 550, a network testing component 552, a device testing component 555, a collaboration component 556, and a selection component 558. The collaboration component 556 can directly provide collaboration services including video conferencing and audio conferencing. The collaboration component 556 can also facilitate certain instances of content sharing.

The user records component 550 can maintain subscription information, when relevant. The user records component 550 can also include records of a user's previous collaboration sessions. The data from the previous user collaboration sessions can include the types of content shared, whether editing occurred, the collaboration mechanisms used during those sessions, any error messages or complaints received from one or more users in a collaboration session, user preferences, and other characteristics of past user collaboration sessions.

The network testing component 552 can be used to ascertain the available bandwidth and other network characteristics between the various devices entering into a collaboration session. The network testing component 552 can then communicate this information out to a component, such as selection component 513, that is attempting to ascertain the optimum collaboration mechanism for a particular circumstance.

The device testing component 555 can query devices within a collaboration session to ascertain the hardware profile as well as current operating characteristics. The hardware profile may be useful to understand what kind of resolution, for example, a tablet or a smartphone, may be able to handle. The device testing component 555 can also query a component such as hardware status component 522 to determine current load or availability of CPU, GPU, memory, or other components and communicate this data to a selection component 513.

The selection component 558 can work in conjunction with the selection component 513 or be an alternative to selection component 513. In other words, the selection component 558 could facilitate or make the selection of the collaboration mechanism. The selection component's 558 inclusion within the collaboration service 212 can be optional.

Turning now to FIG. 6, a flow chart showing a method 600 of selecting a collaboration mechanism to share content from a source computer device to a destination computer device is shown, in accordance with an aspect of the present invention.

At step 610, a request is received through a collaboration application running on a source computing device to share content with a destination user. The destination user is actively using a destination computing device and is engaged in a collaboration session. A plurality of collaboration mechanisms is available to communicate the content from the source computing device to the destination computing device. The collaboration application can be an application that enables users to communicate synchronously using voice with each other through different computing devices.

At step 620, a plurality of collaboration characteristics is ascertained for a collaboration environment that comprises the source computing device, the destination computing device, and a network over which the content is to be communicated from the source computing device to the destination computing device. The collaboration environment may include multiple destination computing devices.

The characteristics for the destination computing device can comprise specifications for a central processing unit (“CPU”) of the destination computing device and a present processing load for the CPU. The characteristics can also comprise specifications for a graphics processing unit (“GPU”) of the destination computing device and a present processing load for the GPU.

The characteristics can include network characteristics. For example, a latency period for a network connection between the source computing device and the destination computing device, an available source network bandwidth for the source computing device to output the content, and an available destination network bandwidth for the destination computing device to receive the content could each be a characteristic.

The collaboration characteristics can comprise a battery status indicating that the destination computing device is not presently using battery power to operate. The characteristics can also include charge level for a battery when the destination device is running on battery power.

The plurality of collaboration characteristics can comprise present availability information for a collaboration service hosted in a data center that facilitates one or more active collaboration mechanisms. The availability information can be available computing resources, such as processing or network resources.

At step 630, without input from the source user or the destination user, an active collaboration mechanism is selected for use to communicate the content, rather than an available static collaboration mechanism, because the plurality of collaboration characteristics satisfies a criteria for using the active collaboration mechanism. Different ways of satisfying the criteria are possible. In one aspect, the criteria comprise one or more threshold values (one value per characteristic) that differentiate between an environment in which active collaboration mechanisms can be used and an environment in which active collaboration mechanisms cannot be used. Different criteria or thresholds can apply to each available active collaboration mechanism. For example, a desktop sharing with lower resolution may have a threshold of 128 kbps of available network bandwidth. A higher resolution desktop sharing collaboration mechanism may have a 400 kbps of available network bandwidth threshold. When the threshold for any available active collaboration mechanism is satisfied, then “the criteria” can be satisfied.

In a second method of satisfying the criteria, the plurality of collaboration characteristics is evaluated by a machine learning mechanism that considers many of the characteristics together and determines whether any active collaboration mechanisms are an optimal selection for the present characteristics. When the machine learning mechanism does not select an active collaboration mechanism, then the criteria is satisfied. The training data that is used to train the machine learning mechanism can include the plurality of collaboration characteristics along with tags that indicate whether the active collaboration mechanism is optimized for the characteristics. Alternatively, the training data can indicate what collaboration mechanism is optimum for a given set of collaboration characteristics. The training data can effectively incorporate the hard thresholds, because it is generated to make sure that an active collaboration mechanism is not chosen when, for example, inadequate bandwidth is available to facilitate the active collaboration mechanism.

The criteria can comprise an available processing capacity of the CPU, the GPU, or both the CPU and GPU exceeding an anticipated processing load generated by the active collaboration mechanism by more than a threshold amount. The available processing capacity can be calculated as a difference between a processing capacity of the CPU or GPU and the present processing load. In one aspect, a different threshold is used for each active collaboration mechanism. An active collaboration mechanism associated with a threshold that is not met can be eliminated from those available for selection to communicate the request. Those that satisfy the thresholds can be included in the group that receives further analysis for selection.

The criteria can comprise network related thresholds. For example, a plurality of collaboration characteristics for the network each may need to satisfy a corresponding quality threshold for using the active collaboration mechanism to communicate the content. The quality threshold could be set differently for each active collaboration mechanism. An active collaboration mechanism associated with a threshold that is not met can be eliminated from those available for selection to communicate the request. Those that satisfy the threshold can be included in the group that receives further analysis for selection.

The criteria can require a destination computing device not to be presently using battery power to operate. The criteria can require a destination computing device to have above a threshold battery level when presently using battery power to operate.

The criteria can further comprise the data center presently having sufficient availability to host the one or more active collaboration sessions.

At step 640, the content from the source computing device is output to the network for communication to the destination computing device. The first active collaboration mechanism is used to communicate the content.

Turning now to FIG. 7, a method 700 of selecting a collaboration mechanism to share content from a source computer to a destination computer is provided.

At step 710, a request is received through a collaboration application running on a source computing device to share content with a destination user' computing device. The destination user is actively using a destination computing device. A plurality of collaboration mechanisms is available to communicate the content from the source computing device to the destination computing device.

At step 720, a plurality of collaboration characteristics is ascertained for a collaboration environment that comprises the source computing device, the destination computing device, and a network over which the content is to be communicated from the source computing device to the destination computing device.

In one aspect, the collaboration characteristics can be descriptions of a previous collaboration between the source user and the destination user.

At step 730, without input from the source user or the destination user, a determination is made that a joint-editing collaboration mechanism is to be used to communicate the content, rather than an available non-editing collaboration mechanism, because the plurality of collaboration characteristics satisfies an intent criteria for using the joint-editing collaboration mechanism. Different ways of satisfying the criteria are possible. In one aspect, the criteria comprises one or more threshold values (one value per characteristic) that identify an environment in which joint-editing mechanisms are likely to be intended. Different criteria or threshold can apply to each available active collaboration mechanism. If the threshold for any available active collaboration mechanism is satisfied, then “the criteria” can be satisfied.

In a second method of satisfying the criteria, the plurality of collaboration characteristics is evaluated by a machine learning mechanism that considers all of the characteristics together and determines whether editing is intended. When the machine learning mechanism does not select a joint-editing collaboration mechanism, then the criteria is not satisfied. The training data that is used to train the machine learning mechanism can include the plurality of collaboration characteristics along with tags that indicate whether the editing is intended. The training data is editorially tagged to indicate which collaboration mechanism is likely intended by the user.

Intent, as used herein, is not a state of mind Rather, intent is a statistical probability that the user has an intent given observable characteristics. The observable characteristics include the collaboration characteristics. The observable characteristics can also include the user's previous choices and collaboration characteristics at the time the choices were made. The observable characteristics can also include explicit user preferences. Data from both the source user and destination users can be considered.

In one aspect, the intent criteria comprises a location of the source computing device and a location of the destination computing device being within a threshold geographic proximity In one aspect, the geographic proximity is less than 200 meters.

At step 740, the content is output from the source computing device to the network for communication to the destination computing device using a first joint-editing collaboration mechanism. In one aspect, the first joint-editing collaboration mechanism is selected from a plurality of joint-editing collaboration mechanisms because the first joint-editing collaboration mechanism is compatible with information rights management criteria associated with the content. In another aspect, the first joint-editing collaboration mechanism is selected from a plurality of joint-editing collaboration mechanisms because the first joint-editing collaboration mechanism is installed on the destination computing device.

Embodiments of the present invention have been described in relation to particular embodiments, which are intended in all respects to be illustrative rather than restrictive. Alternative embodiments will become apparent to those of ordinary skill in the art to which the present invention pertains without departing from its scope.

### Embodiment 1

One or more computer storage media storing computer-executable instructions that, when executed by a computing device having a processor, cause the computing device to perform a method of selecting a collaboration mechanism to share content from a source computer device to a destination computer device, the method comprising: receiving a request through a collaboration application running on a source computing device to share content with a destination computing device, wherein a plurality of collaboration mechanisms are available to communicate the content from the source computing device to the destination computing device; ascertaining a plurality of collaboration characteristics for a collaboration environment that comprises the source computing device, the destination computing device, and a network over which the content is to be communicated from the source computing device to the destination computing device; without input from a source user or a destination user, determining that an active collaboration mechanism is to be used to communicate the content, rather than an available static collaboration mechanism, because the plurality of collaboration characteristics satisfy a criteria for using the active collaboration mechanism; and outputting, using a first active collaboration mechanism, the content from the source computing device to the network for communication to the destination computing device.

### Embodiment 2

The media of any of the above embodiments, wherein the plurality of collaboration characteristics for the destination computing device comprises specifications for a central processing unit (“CPU”) of the destination computing device and a present processing load for the CPU, wherein the criteria comprises an available processing capacity exceeding an anticipated processing load generated by the active collaboration mechanism by more than a threshold amount, the available processing capacity being calculated as a difference between a processing capacity of the CPU and the present processing load.

### Embodiment 3

The media of any of the above embodiments, wherein the plurality of collaboration characteristics for the network is selected from a group consisting of: a latency period for a network connection between the source computing device and the destination computing device, an available source network bandwidth for the source computing device to output the content, and an available destination network bandwidth for the destination computing device to receive the content, and wherein the criteria further comprises the plurality of collaboration characteristics for the network, each satisfying a corresponding quality threshold for using the active collaboration mechanism to communicate the content.

### Embodiment 4

The media of any of the above embodiments, wherein the plurality of collaboration characteristics comprises a battery status indicating that the destination computing device is not presently using battery power to operate, wherein the criteria requires the destination computing device not to be presently using battery power to operate.

### Embodiment 5

The media of any of the above embodiments, wherein the plurality of collaboration characteristics comprises a battery status indicating that the destination computing device is presently using battery power to operate and a battery level, wherein the criteria requires the destination computing device to have above a threshold battery level when presently using battery power to operate.

### Embodiment 6

The media of any of the above embodiments, wherein the plurality of collaboration characteristics for the collaboration environment comprises present availability information for a collaboration service hosted in a data center that facilitates one or more active collaboration mechanisms, and wherein the criteria further comprises the data center presently having sufficient availability to host an additional instance of an active collaboration session.

### Embodiment 7

The media of any of the above embodiments, wherein the collaboration application is an application that enables users to communicate synchronously using voice with each other through different computing devices.

### Embodiment 8

A method of selecting a collaboration mechanism to share content from a source computer to a destination computer, the method comprising: receiving a request through a collaboration application running on a source computing device to share content with a destination computing device, wherein a plurality of collaboration mechanisms are available to communicate the content from the source computing device to the destination computing device; ascertaining a plurality of collaboration characteristics for a collaboration environment that comprises the source computing device, the destination computing device, and a network over which the content is to be communicated from the source computing device to the destination computing device; without input from a source user or a destination user, determining that a joint-editing collaboration mechanism is to be used to communicate the content, rather than an available non-editing collaboration mechanism, because the plurality of collaboration characteristics satisfy an intent criteria for using the joint-editing collaboration mechanism; and outputting, using a first joint-editing collaboration mechanism, the content from the source computing device to the network for communication to the destination computing device.

### Embodiment 9

The method of embodiment 8, wherein the intent criteria comprises a location of the source computing device and a location of the destination computing device being within a threshold geographic proximity

### Embodiment 10

The method of embodiment 9, wherein the threshold geographic proximity is less than 200 meters.

### Embodiment 11

The method of any of embodiments 8-10, wherein the plurality of collaboration characteristics further comprises information about a previous collaboration between the source user and the destination user.

### Embodiment 12

The method of any of embodiments 8-11, wherein the method further comprises selecting the first joint-editing collaboration mechanism from a plurality of joint-editing collaboration mechanisms because the first joint-editing collaboration mechanism is compatible with information rights management criteria associated with the content.

### Embodiment 13

The method of any of embodiments 8-12, wherein the method further comprises selecting the first joint-editing collaboration mechanism from a plurality of joint-editing collaboration mechanisms because a program facilitating the first joint-editing collaboration mechanism is installed on the destination computing device.

### Embodiment 14

The method of any of embodiments 8-13, wherein the plurality of collaboration characteristics for the network is selected from a group consisting of: a latency period for a network connection between the source computing device and the destination computing device, an available source network bandwidth for the source computing device to output the content, and an available destination network bandwidth for the destination computing device to receive the content; and wherein the method further comprises selecting the first joint-editing collaboration mechanism because the plurality of collaboration characteristics satisfy a criteria for using the first joint-editing collaboration mechanism, wherein the criteria further comprises the plurality of collaboration characteristics for the network each satisfying a corresponding quality threshold for using the first joint-editing collaboration mechanism to communicate the content.

### Embodiment 15

The method of any of embodiments 8-14, wherein the method further comprises selecting the first joint-editing collaboration mechanism because the plurality of collaboration characteristics satisfies a criteria required to use the first joint-editing collaboration mechanism, wherein the criteria comprises a quality threshold for a file type of the content.

### Embodiment 16

A source computing device that is configured to generate a collaboration environment through which users of computing devices communicate content, the device comprising: a network interface configured to communicate with a network that is also accessible to a first destination computing device; a computer processor; and a computer storage media having computer executable instructions embodied thereon that, when executed by the computer processor, causes the source computing device to: (1) generate a user interface for a collaboration application that is configured to allow a user of the source computing device to communicate with a destination user of the first destination computing device, the user interface configured to allow a source user to select content for sharing, the collaboration application having a plurality of content sharing mechanisms, (2) ascertain a plurality of collaboration characteristics for the collaboration environment that comprises the source computing device, a destination computing device, a data center configured to facilitate a first active collaboration mechanism, and a network over which the content is to be communicated from the source computing device to the destination computing device, (3) without input from the source user or a destination user, determine that an active collaboration mechanism is to be used to communicate the content, rather than an available static collaboration mechanism, because the plurality of collaboration characteristics satisfies a criteria for using the active collaboration mechanism, and (4) output, using the first active collaboration mechanism, the content from the source computing device to the network for communication to the destination computing device.

### Embodiment 17

The source computing device of embodiment 16, wherein the criteria further comprises a current processing load within the data center configured to facilitate the first active collaboration mechanism being below a threshold.

### Embodiment 18

The source computing device of any of embodiments 16-17, wherein the criteria further comprises the plurality of collaboration characteristics for the network, each satisfying a corresponding quality threshold for using the active collaboration mechanism to communicate the content.

### Embodiment 19

The source computing device of any of embodiments 16-18, wherein the criteria comprises an available processing capacity of the source computing device exceeding an anticipated processing load generated by the active collaboration mechanism by more than a threshold amount, the available processing capacity being calculated as a difference between a processing capacity of the CPU and a present processing load.

### Embodiment 20

The source computing device of any of embodiments 16-19, wherein the content is stored within the computer storage media on the source computing device, and the content is a data file having a file type that is associated with a computer application that is not the collaboration application.

### CONCLUSION

Aspects of the invention have been described to be illustrative rather than restrictive. It will be understood that certain features and subcombinations are of utility and may be employed without reference to other features and subcombinations. This is contemplated by and is within the scope of the claims.

The invention claimed is:

1. One or more computer storage media storing computer-executable instructions that, when executed by a computing device having a processor, cause the computing device to perform a method of selecting a collaboration mechanism to share content from a source computer device to a destination computer device, the method comprising:
receiving a request through a collaboration application running on a source computing device to share content with a destination computing device, wherein a plurality of collaboration mechanisms are available to communicate the content from the source computing device to the destination computing device;
ascertaining a plurality of collaboration characteristics for a collaboration environment that comprises the source computing device, the destination computing device, and a network over which the content is to be communicated from the source computing device to the destination computing device;
without input from a source user or a destination user, determining that an active collaboration mechanism is to be used to communicate the content, rather than an available static collaboration mechanism, because the plurality of collaboration characteristics satisfy a criteria for using the active collaboration mechanism; and
outputting, using a first active collaboration mechanism, the content from the source computing device to the network for communication to the destination computing device.

2. The media of claim 1, wherein the plurality of collaboration characteristics for the destination computing device comprises specifications for a central processing unit (“CPU”) of the destination computing device and a present processing load for the CPU, wherein the criteria comprises an available processing capacity exceeding an anticipated processing load generated by the active collaboration mechanism by more than a threshold amount, the available processing capacity being calculated as a difference between a processing capacity of the CPU and the present processing load.

3. The media of claim 1, wherein the plurality of collaboration characteristics for the network is selected from a group consisting of:
a latency period for a network connection between the source computing device and the destination computing device,
an available source network bandwidth for the source computing device to output the content, and
an available destination network bandwidth for the destination computing device to receive the content; and
wherein the criteria further comprises the plurality of collaboration characteristics for the network, each satisfying a corresponding quality threshold for using the active collaboration mechanism to communicate the content.

4. The media of claim 1, wherein the plurality of collaboration characteristics comprises a battery status indicating that the destination computing device is not presently using battery power to operate, wherein the criteria requires the destination computing device not to be presently using battery power to operate.

5. The media of claim 1, wherein the plurality of collaboration characteristics comprises a battery status indicating that the destination computing device is presently using battery power to operate and a battery level, wherein the criteria requires the destination computing device to have above a threshold battery level when presently using battery power to operate.

6. The media of claim 1, wherein the plurality of collaboration characteristics for the collaboration environment comprises present availability information for a collaboration service hosted in a data center that facilitates one or more active collaboration mechanisms, and wherein the criteria further comprises the data center presently having sufficient availability to host an additional instance of an active collaboration session.

7. The media of claim 1, wherein the collaboration application is an application that enables users to communicate synchronously using voice with each other through different computing devices.

8. A method of selecting a collaboration mechanism to share content from a source computer to a destination computer, the method comprising:
receiving a request through a collaboration application running on a source computing device to share content with a destination computing device, wherein a plurality of collaboration mechanisms are available to communicate the content from the source computing device to the destination computing device;
ascertaining a plurality of collaboration characteristics for a collaboration environment that comprises the source computing device, the destination computing device, and a network over which the content is to be communicated from the source computing device to the destination computing device;
without input from a source user or a destination user, determining that a joint-editing collaboration mechanism is to be used to communicate the content, rather than an available non-editing collaboration mechanism, because the plurality of collaboration characteristics satisfy an intent criteria for using the joint-editing collaboration mechanism; and
outputting, using a first joint-editing collaboration mechanism, the content from the source computing device to the network for communication to the destination computing device.

9. The method of claim 8, wherein the intent criteria comprises a location of the source computing device and a location of the destination computing device being within a threshold geographic proximity.

10. The method of claim 9, wherein the threshold geographic proximity is less than 200 meters.

11. The method of claim 8, wherein the plurality of collaboration characteristics further comprises information about a previous collaboration between the source user and the destination user.

12. The method of claim 8, wherein the method further comprises selecting the first joint-editing collaboration mechanism from a plurality of joint-editing collaboration mechanisms because the first joint-editing collaboration mechanism is compatible with information rights management criteria associated with the content.

13. The method of claim 8, wherein the method further comprises selecting the first joint-editing collaboration mechanism from a plurality of joint-editing collaboration mechanisms because a program facilitating the first joint-editing collaboration mechanism is installed on the destination computing device.

14. The method of claim 8, wherein the plurality of collaboration characteristics for the network is selected from a group consisting of:
a latency period for a network connection between the source computing device and the destination computing device,
an available source network bandwidth for the source computing device to output the content, and
an available destination network bandwidth for the destination computing device to receive the content; and
wherein the method further comprises selecting the first joint-editing collaboration mechanism because the plurality of collaboration characteristics satisfy a criteria for using the first joint-editing collaboration mechanism, wherein the criteria further comprises the plurality of collaboration characteristics for the network each satisfying a corresponding quality threshold for using the first joint-editing collaboration mechanism to communicate the content.

15. The method of claim 8, wherein the method further comprises selecting the first joint-editing collaboration mechanism because the plurality of collaboration characteristics satisfies a criteria required to use the first joint-editing collaboration mechanism, wherein the criteria comprises a quality threshold for a file type of the content.

16. A source computing device that is configured to generate a collaboration environment through which users of computing devices communicate content, the device comprising:
a network interface configured to communicate with a network that is also accessible to a first destination computing device;
a computer processor; and
a computer storage media having computer executable instructions embodied thereon that, when executed by the computer processor, causes the source computing device to:
(1) generate a user interface for a collaboration application that is configured to allow a user of the source computing device to communicate with a destination user of the first destination computing device, the user interface configured to allow a source user to select content for sharing, the collaboration application having a plurality of content sharing mechanisms,
(2) ascertain a plurality of collaboration characteristics for the collaboration environment that comprises the source computing device, a destination computing device, a data center configured to facilitate a first active collaboration mechanism, and a network over which the content is to be communicated from the source computing device to the destination computing device,
(3) without input from the source user or a destination user, determine that an active collaboration mechanism is to be used to communicate the content, rather than an available static collaboration mechanism, because the plurality of collaboration characteristics satisfies a criteria for using the active collaboration mechanism, and
(4) output, using the first active collaboration mechanism, the content from the source computing device to the network for communication to the destination computing device.

17. The source computing device of claim 16, wherein the criteria further comprises a current processing load within the data center configured to facilitate the first active collaboration mechanism being below a threshold.

18. The source computing device of claim 16, wherein the criteria further comprises the plurality of collaboration characteristics for the network, each satisfying a corresponding quality threshold for using the active collaboration mechanism to communicate the content.

19. The source computing device of claim 16, wherein the criteria comprises an available processing capacity of the source computing device exceeding an anticipated processing load generated by the active collaboration mechanism by more than a threshold amount, the available processing capacity being calculated as a difference between a processing capacity of the CPU and a present processing load.

20. The source computing device of claim 16, wherein the content is stored within the computer storage media on the source computing device, and the content is a data file having a file type that is associated with a computer application that is not the collaboration application.
